(19) United States
(12) Patent Application Publication
(10) Pub. No.: US 2022/0061209 A1
(43) Pub. Date: Mar. 3, 2022

(54) GARDENING TOOL LEAF TAMPER

(71) Applicant: Sean P. Denny, Springfield, IL (US)

(72) Inventor: Sean P. Denny, Springfield, IL (US)

(21) Appl. No.: 17/005,930

(22) Filed: Aug. 28, 2020

(51) Int. Cl. A01D 11/06; A01D 7/00

(52) U.S. Cl. CPC A01D 11/06; A01D 7/00

(57) ABSTRACT

A leaf tamper for use on a gardening tool includes a mounting collar received over, and removably secured to, an end of an elongated tool handle opposite a tool head. A tamper plate extends outwardly from an outer end of the collar perpendicular to an axis of the collar.

### BACKGROUND OF THE INVENTION

### Field of the Invention

The present invention is broadly concerned with apparatus for compacting materials and, more particularly, with a leaf tamper removably attached to an elongated handle of a gardening tool, such as a leaf rake or the like.

### Background & Description of the Related Art

Lawn maintenance often requires gathering leaves, twigs, grass and weed clippings, and the like into piles or bunches. A leaf rake, also known as a yard broom, is often used for gathering such debris. A leaf rake is a long used, relatively simple gardening tool of which there are many varieties with significant differences. Gardeners and landscapers who wish to maintain a well-groomed lawn will regularly cut the grass and will use these standard hand tools to gather loose grass cuttings or clippings, fallen leaves, and other unattached relatively light lawn or yard debris into piles to facilitate disposal thereof. Although there are alternate and more modern solutions to leaf raking and subsequent removal, such as leaf blowers, bag-equipped power lawn mowers, or even burning in place, these are usually either noisy, comparatively expensive, sometimes unsafe, or environmentally undesirable. Thus, leaf rakes are still in relatively wide use.

Once gathered, the lawn debris must be contained for disposal by placing it in a container or by being bagged, often for pickup by trash or recycling services. Leaf bags for this purpose are usually made of a flexible, sturdy paper. Dried leaves and yard clippings are typically low in density and of such shapes that they do not naturally pack very densely in a leaf bag. It is usually desirable to pack the debris to such a degree that a minimum number of leaf bags are required while maintaining a weight per bag which can be conveniently lifted, carried, and stacked.

Some compacting of lawn debris can be accomplished by using the hands or feet. However, such a manner of compacting is awkward and not particularly effective. A typical leaf rake has a straight, cylindrical, elongated, inflexible, either metallic, hard plastic or wooden handle, that is attached to a fan-type rake head usually consisting of a polypropylene or metallic plurality of somewhat resilient teeth or tines that are inwardly curved or angled at their edges. Because of their shape, conventional leaf rakes are not well suited for compacting lawn debris.

Various kinds of devices for compacting or tamping leaves and yard debris in bags have been suggested. Some known devices are separate tools which are designed for compacting or tamping leaves and lawn debris. In other cases, the handle of the implement is made removable from the tool head, and the tool head is replaced by a tamper member.

### SUMMARY OF THE INVENTION

The present invention provides embodiments of a gardening tool or implement with a tamper or compacter member which is removably secured to an elongated handle of the tool.

An embodiment of a leaf tamper or leaf tamper assembly, according to the present invention, is configured for use on an end of an elongated handle of a gardening tool, such as a gardening tool configured for moving and gathering lawn debris, and includes a mounting collar or stem configured to enable the collar to be removably secured to an end of the elongated handle of the gardening tool, the collar having a collar axis and an outer end, and a tamper plate extending outwardly from the outer end of the mounting collar in a plane substantially perpendicular to the collar axis, the tamper plate having an inner surface facing the outer end of the mounting collar and an opposite outer surface. Preferably, the leaf tamper is sized and shaped in such a manner as to enable use of the gardening tool for normal gardening functions with the leaf tamper secured on the handle thereof.

Embodiments of the leaf tamper may include a peripheral wall extending peripherally from the inner surface of tamper plate. An outer surface of the tamper plate may have a somewhat concave shape or a somewhat convex shape. A selectively shaped relief may be formed on the inner or outer surface of the tamper plate. Such a relief may be decorative, such a leaf shape, or a functional shape, such as bumps or ribs formed on the outer surface to prevent leaves from slipping out from under the tamper plate.

Embodiments of the leaf tamper may include a threaded connection removably securing the mounting collar to an end of the elongated handle. The threaded connection may be in the form of internal threads formed on an internal surface of the mounting collar which cooperate with external threads formed on the external surface of the outer end of the elongated handle of the gardening tool. Alternatively the threaded connection may include a threaded fastener engaged between the mounting collar and an end of the elongated handle and removably securing the mounting collar to the handle. The threaded fastener may be in the form of a threaded thumbscrew engaged between the mounting collar and an end of the elongated handle and including a finger grip to enable manual grasping and rotation of the thumbscrew to removably secure the mounting collar to the handle.

Embodiments of the leaf tamper may be provided combination with a gardening tool having an elongated handle. The gardening tool may be a tool configured for moving and gathering lawn debris and having an elongated handle.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a perspective view of a gardening tool, such as a leaf rake or yard broom, having a leaf tamper according to the present invention secured thereon.

FIG. 2 is a side elevational view, at a reduced scale, of the leaf rake, shown in an inverted orientation, and having the leaf tamper of the present invention positioned thereon.

FIG. 3 is a side elevational view illustrating leaves in a leaf bag which is supported by a container, such as a barrel, with portions of the bag and barrel broken away to illustrate use of the leaf rake with the leaf tamper of the present invention to compact leaves within the bag.

FIG. 4 is a somewhat enlarged bottom plan view of a tamper plate of the leaf tamper, the tamper plate having a rectangular shape with rounder corners.

FIG. 5 is a view similar to FIG. 4 and illustrates a tamper plate of the leaf tamper having an oval or elliptical shape.

FIG. 6 is a view similar to FIG. 4 and illustrates a tamper plate of the leaf tamper having a substantially circular shape.

FIG. 7 is an enlarged fragmentary perspective view of a leaf tamper having a shaped relief formed on a surface thereof.

FIG. 8 is a diametric cross sectional view at a reduced scale and illustrates a leaf tamper with a tamper plate having a somewhat concave outer surface.

FIG. 9 is a view similar to FIG. 8 and illustrates a leaf tamper with a tamper plate having a somewhat convex outer surface.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure

Referring to the drawings in more detail, the reference number 1 generally designates an embodiment of a garden tool leaf tamper or leaf tamper structure according to the present invention. The leaf tamper 1 is configured for removable attachment to a gardening tool 3, such as a leaf rake or the like, having an elongated handle 5 secured to a gardening tool head 7. The leaf tamper 1 provides a convenient means for tamping or compacting lawn debris 9, such as leaves, grass clippings, twigs, or the like, particularly debris 9 (FIG. 3) within a leaf bag 11.

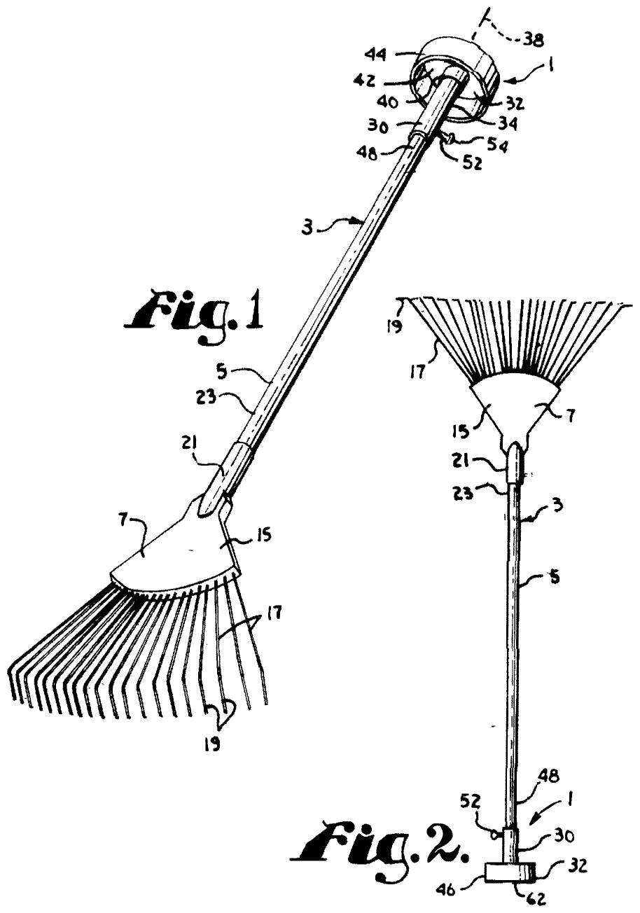

Referring to FIGS. 1-3, the illustrated gardening or lawn tool 3 is a leaf rake, also known as a yard broom, having the tool head 7 formed by a tine support or support member 15 with a plurality of tines 17 radiating therefrom in a fan shaped pattern. The tines 17 are typically formed of a resiliently flexible metal and have outer ends 19 angled away from the tine support 15. The tine support 15 has a mounting sleeve 21 opposite the tines 17 which receives a lower end 23 of the handle or shaft 5 of the tool 3. The tool head 7 is joined to the handle 5, by way of the sleeve 21, as by friction, a fastener (not shown), or by cooperating threads (not shown) formed on the lower end 23 of the handle 5 and within the sleeve 21. The tool 3 is used to move and gather lawn debris 9 into piles for disposal. The resilient flexibility of the tines 17 enable the debris 9 to be moved without damaging the grass or digging into the soil.

The illustrated leaf tamper 1 includes a mounting collar 30 having a tamper plate 32 joined to an outer end 34 of the collar 30. The mounting collar 30 is a cylindrical, sleeve-like member which receives an outer end 36 of the handle 5 therein. The collar 30 has a cylindrical collar axis 38. The tamper plate 32 may be a planar or flat member which is used to tamp or compact the lawn debris 9. The tamper plate 32 extends or radiates from the upper end 36 of the collar 30 and is oriented substantially perpendicular to the collar axis 38. The illustrated tamper plate 32 has a cylindrical socket 40 projecting from an inner surface 42 thereof which receives the outer end 40 of the mounting collar 30. The illustrated tamper plate 32 has a cylindrical wall 44 extending inwardly from a periphery 46 thereof in surrounding relation to the outer end 36 of the mounting collar 30. The wall 30 tends to stiffen the tamper plate 32. The tamper plate 32 may be joined to the mounting collar 30, as by welding, or may be integral or monolithic therewith, as a consequence of being molded or cast therewith.

The leaf tamper 1 may be secured to an upper end 48 of the handle 5 my means such as a threaded connection 50. The threaded connection 50 may be a threaded fastener 52 engaged between the mounting collar 30 and the upper end 48 of the handle. The threaded fastener 52 may include a screw threaded into a hole (not shown) which bears against the upper handle end 48, in the manner of a set screw, or one which penetrates the end 48. The fastener 52 may be in the form of a thumbscrew having a finger grip 54 to enable manual insertion or removal of the screw 52, to removably secure the leaf tamper 1 on the handle 5. Additionally, the threaded connection 50 may include a threaded socket (not shown) embedded in the upper handle end 48 which received a threaded fastener through an unthreaded hole (not shown) formed in the mounting collar 30.

In an embodiment of the leaf tamper 1, the threaded connection 50 may be external threads 56 (FIG. 8) formed in an surface of the upper end 48 which engage internal threads 58 formed on an inner surface of the mounting collar 30. The threaded handle upper end 48 and threaded mounting collar 30 may be provided if the leaf tamper 1 is manufactured in combination with the gardening tool 3.

It is foreseen that embodiments of the leaf tamper 1 may include non-threaded connections to secure the mounting collar 30 to the upper end 48 of the handle 5. Such non-threaded connections may include rivets, cotter keys, or the like (not shown). Non-threaded connections of the mounting collar 30 to the handle 5, along with the threaded connections 50, may also be provided for a leaf tamper 1 manufactured in combination with the gardening tool 3.

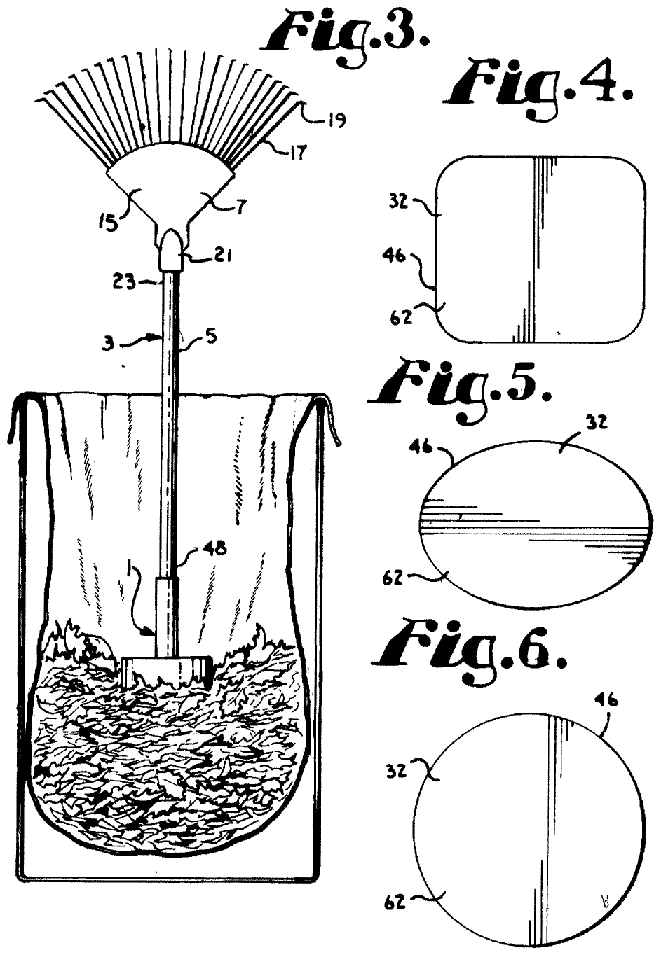

The tamper plate 32 shown in FIGS. 1-3, 6, and 7 has the outer periphery 46 which is substantially circular in shape. It is foreseen that the tamper plate 32 could have an outer periphery 46 other than circular, such as the rectangular or square periphery 46 shown in FIG. 4 or the oval or elliptical outer periphery 46 shown in FIG. 5.

The inner surface 42 of the tamper plate 32 is shown as substantially planar or flat. An outer surface 62 of the tamper plate 32, opposite the inner surface 42, can also be flat, as shown in FIG. 2 and FIGS. 4-6. The outer surface 62 could alternatively, be of some other shape. The outer surface 62 of the tamper plate 32 shown in FIG. 8 has a somewhat concave or dished shaped. Such a concave shape may have the advantage of preventing lawn debris 9 from slipping from beneath the leaf tamper 1 when being tamped or compacted. It is also foreseen that the outer surface 62 could have a somewhat convex shape, as shown in FIG. 9.

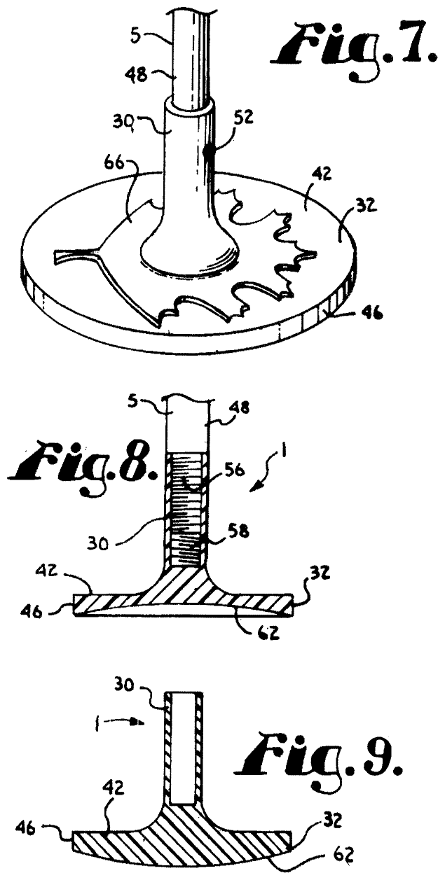

Referring to FIG. 7, the tamper plate 32 may have a shaped relief or relief feature 66 formed on the inner surface 42 and/or the outer surface 62 thereof. The relief feature 66 is raised or embossed from the surface 42 or 62 and may be decorative or functional. The relief feature 66 shown in FIG. 7 has the shape of a leaf which may be similar to the shape of a leaf of a tree which is common in or characteristic of a geographic region. Other relief shapes or designs for the relief feature 66 are foreseen. For example, the relief feature 66 may be a pattern of bumps or lines (not shown) formed on the outer surface 62, for the purpose of resisting the movement of lawn debris 9 out from under the leaf tamper 1 during tamping. It is also foreseen that features (not shown), similar to the relief feature 66, may be debossed or counter-relieved into the surfaces 42 and/or 62.

In use, the tool 3 is used with the tool head 7 in a downward position to gather lawn debris 9 into a pile or piles. Debris 9 from such a pile is placed in the leaf bag 11 where it may be tamped or compacted, using the tool 3 with the leaf tamper 1 in a downward position, to increase the amount of debris 9 that can be contained within the bag 11. During placement of the debris 9 in the bag 11 and compacting the debris, the bag 11 may be supported, as by a barrel 70 (FIG. 3). The leaf filled bag 11 can then be stacked, as for pickup by a service, or otherwise disposed of.

It is to be understood that while certain forms of the present invention have been illustrated and described herein, it is not to be limited to the specific forms or arrangement of parts described and shown.

What is claimed as new and desired to be secured by Letters Patent is:

1. A leaf tamper for use on an end of an elongated handle of a gardening tool and comprising:
(a) a mounting collar configured to enable the collar to be removably secured to an end of an elongated handle of a gardening tool, the collar having a collar axis and an outer end; and
(b) a tamper plate extending outwardly from the outer end of the mounting collar in a plane substantially perpendicular to the collar axis, the tamper plate having an inner surface facing the outer end of the mounting collar and an opposite outer surface.

2. A leaf tamper as set forth in claim 1 and including:
(a) a peripheral wall extending peripherally from the inner surface of tamper plate.

3. A leaf tamper as set forth in claim 1 wherein:
(a) the outer surface of the tamper plate has a somewhat concave shape.

4. A leaf tamper as set forth in claim 1 wherein:
(a) the outer surface of the tamper plate has a somewhat convex shape.

5. A leaf tamper as set forth in claim 1 wherein:
(a) a shaped relief is formed on a surface of the tamper plate thereof.

6. A leaf tamper as set forth in claim 1 and including:
(a) a threaded connection removably securing the mounting collar to an end of the elongated handle.

7. A leaf tamper as set forth in claim 6 in combination with a gardening tool including an elongated handle with an outer surface and with an upper tool end, wherein the threaded connection includes:
(a) internal threads formed on an internal surface of the mounting collar; and
(b) external threads formed on the external surface of the outer end of the elongated handle of the gardening tool, the internal threads and external threads cooperating to removably secure the leaf tamper on the outer end of the handle of the tool.

8. A leaf tamper as set forth in claim 6 wherein the threaded connection includes:
(a) a threaded fastener engaged between the mounting collar and an end of the elongated handle and removably securing the mounting collar to the handle.

9. A leaf tamper as set forth in claim 6 wherein the threaded connection includes:
(a) a threaded thumbscrew engaged between the mounting collar and an end of the elongated handle; and
(b) the thumbscrew including a finger grip to enable manual grasping and rotation of the thumbscrew to removably secure the mounting collar to the handle.

10. A leaf tamper as set forth in claim 1 wherein:
(a) the leaf tamper is sized and shaped in such a manner as to enable use of a gardening tool for normal gardening functions with the leaf tamper secured thereon.

11. A leaf tamper as set forth in claim 1 in combination with:
(a) a gardening tool having an elongated handle.

12. A leaf tamper as set forth in claim 1 in combination with:
(a) a gardening tool for moving and gathering lawn debris and having an elongated handle.

13. A leaf tamper for use on an end of an elongated handle of a gardening tool and comprising:
(a) a mounting collar configured to enable the collar to be removably secured to an end of an elongated handle of a gardening tool, the collar having a collar axis and an outer end;
(b) a tamper plate extending outwardly from the outer end of the mounting collar in a plane substantially perpendicular to the collar axis, the tamper plate having an inner surface facing the outer end of the mounting collar and an opposite outer surface;
(c) a threaded removably securing the mounting collar and an end of the elongated handle; and
(d) the leaf tamper being sized and shaped in such a manner as to enable use of a gardening tool for normal gardening functions with the leaf tamper secured thereon.

14. A leaf tamper as set forth in claim 13 and including:
(a) a peripheral wall extending peripherally from the inner surface of tamper plate.

15. A leaf tamper as set forth in claim 13 wherein:
(a) the outer surface of the tamper plate has a somewhat concave shape.

16. A leaf tamper as set forth in claim 13 wherein:
(a) the outer surface of the tamper plate has a somewhat convex shape.

17. A leaf tamper as set forth in claim 13 wherein:
(a) a shaped relief is formed on a surface of the tamper plate thereof.

18. A leaf tamper as set forth in claim 13 wherein the threaded connection includes:
(a) a threaded fastener engaged between the mounting collar and an outer end of the handle to removably secure the mounting collar to the handle.

19. A leaf tamper as set forth in claim 13 wherein the threaded connection includes:
(a) a threaded thumbscrew engaged between the mounting collar and an outer end of the handle and including a finger grip to enable manual grasping and rotation of the thumbscrew to removably secure the mounting collar to the handle.

20. A leaf tamper in combination with a gardening tool configured to enable moving and gathering lawn debris and including an elongated handle with an upper end, the leaf tamper comprising:
(a) a mounting collar configured to enable the collar to be removably secured to an end of the elongated handle of the gardening tool, the collar having a collar axis and an outer end;
(b) a tamper plate extending outwardly from the outer end of the mounting collar in a plane substantially perpendicular to the collar axis, the tamper plate having an inner surface facing the outer end of the mounting collar and an opposite outer surface;
(c) a threaded connection removably securing the mounting collar to the upper end of the handle; and
(d) the leaf tamper being sized and shaped in such a manner as to enable use of the gardening tool for normal gardening functions with the leaf tamper secured thereon.

21. A leaf tamper as set forth in claim 20 and including:
(a) a peripheral wall extending peripherally from the inner surface of tamper plate.

22. A leaf tamper as set forth in claim 20 wherein:
(a) the outer surface of the tamper plate has a somewhat concave shape.

23. A leaf tamper as set forth in claim 20 wherein:
(a) the outer surface of the tamper plate has a somewhat convex shape.

24. A leaf tamper as set forth in claim 20 wherein:
(a) a shaped relief is formed on a surface of the tamper plate thereof.

25. A leaf tamper as set forth in claim 20 wherein the threaded connection includes:
(a) a threaded fastener engaged between the mounting collar and the upper end of the handle to removably secure the mounting collar to the handle.

26. A leaf tamper as set forth in claim 20 wherein the threaded connection includes:
(a) a threaded thumbscrew engaged between the mounting collar and the upper end of the handle, the thumbscrew including a finger grip to enable manual grasping and rotation of the thumbscrew to removably secure the mounting collar to the handle.

27. A leaf tamper comprising:
(a) a rake having an elongate handle with a tool head at a first end thereof; and
(b) a tamper plate affixed to a second end of the handle; the tamper plate extending radially outward from the handle and having a curvate outer edge surrounding the plate and an upper surface adapted to tamp leaves and debris into a receiving structure.

28. The tamper according to claim 27 wherein:
(a) the tamper plate is fixedly formed with the handle.
